(19) United States
(12) Patent Application Publication
(10) Pub. No.: US 2016/0017838 A1
(43) Pub. Date: Jan. 21, 2016

(54) TEMPERATURE MAINTAINING MEMBER FOR CYLINDER-BORE WALL

(71) Applicant: NICHIAS CORPORATION, Tokyo (JP)

(72) Inventors: Kazuaki Nishio, Tokyo (JP); Yoshifumi Fujita, Tokyo (JP)

(73) Assignee: NICHIAS CORPORATION, Tokyo (JP)

(21) Appl. No.: 14/775,034

(22) PCT Filed: Mar. 13, 2014
(86) PCT No.: PCT/JP2014/056678

§ 371 Date: Sep. 11, 2015

(30) Foreign Application Priority Data
Mar. 15, 2013 (JP) 2013-053935

(51) Int. Cl. F02F 1/00; F02F 7/00; F02F 1/10

(52) U.S. Cl. CPC F02F 1/004; F02F 1/10; F02F 7/0007

(57) ABSTRACT

A cylinder bore wall insulating member has a contact surface that comes in contact with a wall surface of a cylinder bore wall that forms a cylinder block of an internal combustion engine and defines a groove-like coolant passage, the contact surface being formed of an elastomer or a resin material, and the ratio ((actual area of contact/formation area of contact surface)×100) of the actual area of contact to the formation area of the contact surface being 1 to 50%. The cylinder bore wall insulating member can be easily fitted into the groove-like coolant passage.

### TECHNICAL FIELD

The present invention relates to a cylinder bore wall insulating member that is disposed to come in contact with the wall surface of a cylinder bore wall that forms a cylinder block of an internal combustion engine and defines a groove-like coolant passage.

### BACKGROUND ART

An internal combustion engine is designed so that fuel explodes within the cylinder bore when the piston is positioned at top dead center, and the piston is moved downward due to the explosion. Therefore, the upper area of the cylinder bore wall increases in temperature as compared with the lower area of the cylinder bore wall. Accordingly, a difference in the amount of thermal deformation occurs between the upper area and the lower area of the cylinder bore wall (i.e., the upper area of the cylinder bore wall expands to a large extent as compared with the lower area of the cylinder bore wall).

As a result, the frictional resistance of the piston against the cylinder bore wall increases, and the fuel consumption increases. Therefore, a reduction in difference in the amount of thermal deformation between the upper area and the lower area of the cylinder bore wall has been desired.

Attempts have been made to control the cooling efficiency in the upper area and the lower area of the cylinder bore wall due to the coolant by disposing a spacer in a groove-like coolant passage to adjust the flow of the coolant in the groove-like coolant passage so that the cylinder bore wall has a uniform temperature. For example, Patent Document 1 discloses an internal combustion engine heating medium passage partition member that is disposed in a groove-like heating medium passage formed in a cylinder block of an internal combustion engine to divide the groove-like heating medium passage into a plurality of passages, the heating medium passage partition member including a passage division member that is formed at a height above the bottom of the groove-like heating medium passage, and series as a wall that divides the groove-like heating medium passage into a bore-side passage and a non-bore-side passage, and a flexible lip member that is formed from the passage division member in the opening direction of the groove-like heating medium passage, the edge area of the flexible lip member being formed of a flexible material to extend beyond the inner surface of one of the groove-like heating medium passages, the edge area of the flexible lip member coming in contact with the inner surface at a middle position of the groove-like heating medium passage in the depth direction due to the flexure restoring force after insertion into the groove-like heating medium passage to separate the bore-side passage and the non-bore-side passage.

According to the internal combustion engine heating medium passage partition member disclosed in Patent Document 1, since the temperature of the cylinder bore wall can be made uniform to a certain extent, the difference in the amount of thermal deformation between the upper area and the lower area of the cylinder bore wall can be reduced. However, a further reduction in the difference in the amount of thermal deformation between the upper area and the lower area of the cylinder bore wall has been desired.

Patent Document 2 discloses a cylinder bore wall insulating member that aims to provide an internal combustion engine in which the cylinder bore wall has a uniform temperature. Patent Document 2 discloses a rubber material and a resin material as a material for forming the insulating member.

### RELATED-ART DOCUMENT

### Patent Document

Patent Document 1: JP-A-2008-31939 (claims)
Patent Document 2: WO2011/1162096 (claims)

### SUMMARY OF THE INVENTION

### Technical Problem

A cylinder bore wall insulating member having a contact surface formed of a rubber material or a resin material is fitted into a groove-like coolant passage by moving the cylinder bore wall insulating member toward the bottom of the groove-like coolant passage in a state in which the contact surface of the insulating member comes in contact with the wall surface of the groove-like coolant passage. When the contact surface is formed of a rubber material or a resin material, the frictional force between the wall surface of the groove-like coolant passage and the contact surface increases.

Specifically, since a large amount of force is required to fit the cylinder bore wall insulating member into the cylinder block, a special jig may be required, or it may be difficult to fit the cylinder bore wall insulating member into the cylinder block, or it may take time to fit the cylinder bore wall insulating member into the cylinder block.

### Solution to Problem

The inventors of the invention conducted extensive studies in order to solve the above problem. As a result, the inventors found that it is possible to reduce the frictional force that occurs when fitting the cylinder bore wall insulating member into the groove-like coolant passage, and easily fit the cylinder bore wall insulating member into the groove-like coolant passage by subjecting the contact surface of the cylinder bore wall insulating member that is formed of an elastomer (e.g., rubber material) or a resin material to processing that reduces the area of contact. This finding has led to the completion of the invention.

A first aspect of the invention provides a cylinder bore wall insulating member having a contact surface that comes in contact with a wall surface of a cylinder bore wall that forms a cylinder block of an internal combustion engine and defines a groove-like coolant passage, the contact surface being formed of an elastomer or a resin material, and the ratio ((actual area of contact/formation area of contact surface)×100) of the actual area of contact to the formation area of the contact surface being 1 to 50%.

A second aspect of the invention provides a cylinder bore wall insulating member having a contact surface that comes in contact with a wall surface of a cylinder bore wall that forms a cylinder block of an internal combustion engine and defines a groove-like coolant passage, the contact surface being formed of an elastomer or a resin material, and the coefficient of static friction of the contact surface having been reduced by subjecting the contact surface to processing that reduces the area of contact.

### Advantageous Effects of the Invention

The aspects of the invention thus make it possible to easily fit the cylinder bore wall insulating member into the groove-like coolant passage.

### BRIEF DESCRIPTION OF DRAWINGS

FIG. 1 is a schematic plan view illustrating a state in which a cylinder bore wall insulating member is disposed in a cylinder block.

FIG. 2 is an end view taken along the line x-x illustrated in FIG. 1.

FIG. 3 is a perspective view illustrating the cylinder block illustrated in FIG. 1.

FIG. 4 is a schematic view illustrating the cylinder bore wall insulating member illustrated in FIG. 1.

FIG. 5 is a schematic view illustrating an example of a cylinder bore wall insulating member and a securing member.

FIG. 6 is a view illustrating the placement position of an insulating member (1).

FIG. 7 is a view illustrating the circumferential direction (23) of a cylinder bore wall.

FIG. 8 is a schematic view illustrating a state in which a cylinder bore wall insulating member is fitted into a groove-like coolant passage.

FIG. 9 is a view illustrating a contact surface of the cylinder bore wall insulating member illustrated in FIG. 4.

FIG. 10 is a schematic view illustrating an example of a cylinder bore wall insulating member.

FIG. 11 is a schematic view illustrating an example of a cylinder bore wall insulating member.

FIG. 12 is a schematic view illustrating an example of a cylinder bore wall insulating member.

### DESCRIPTION OF EMBODIMENTS

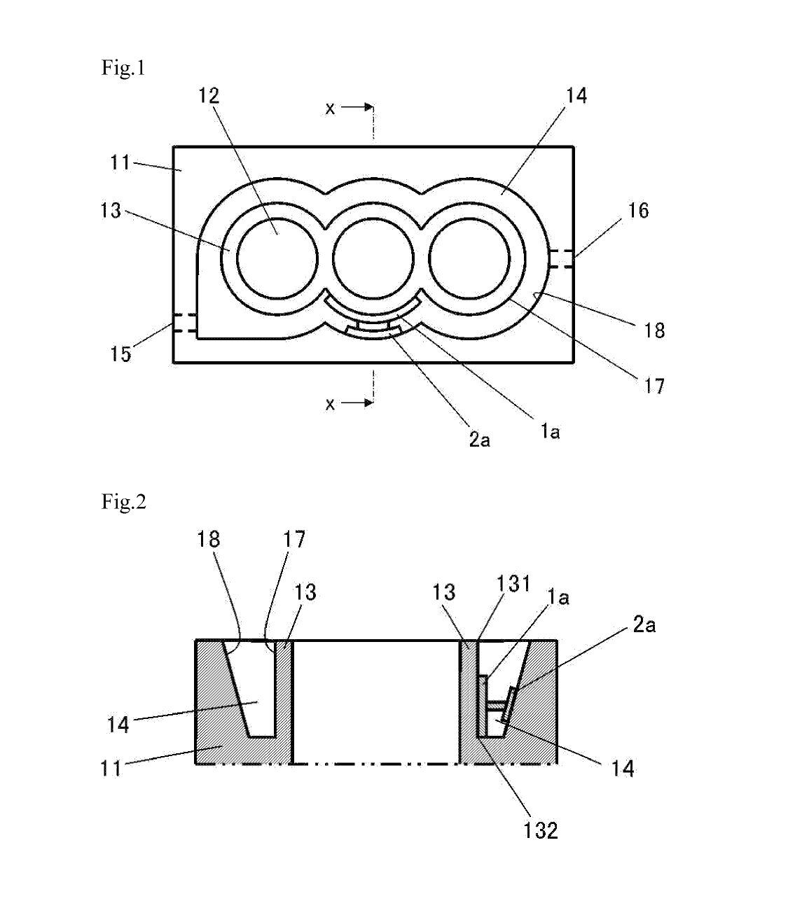

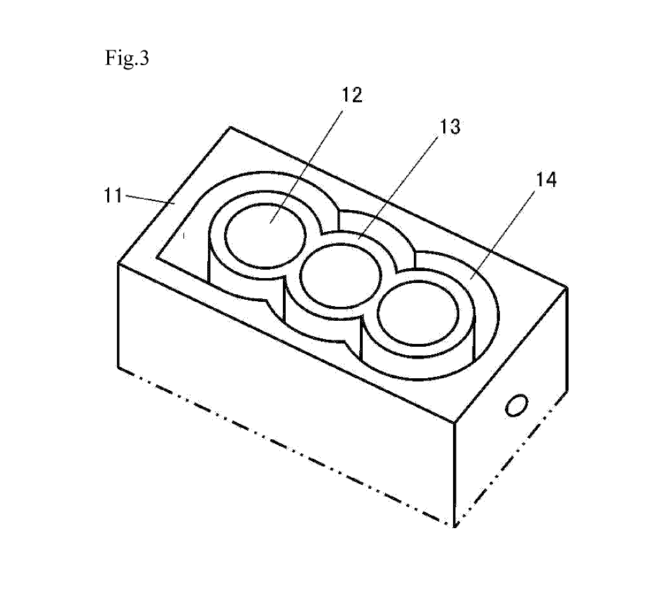

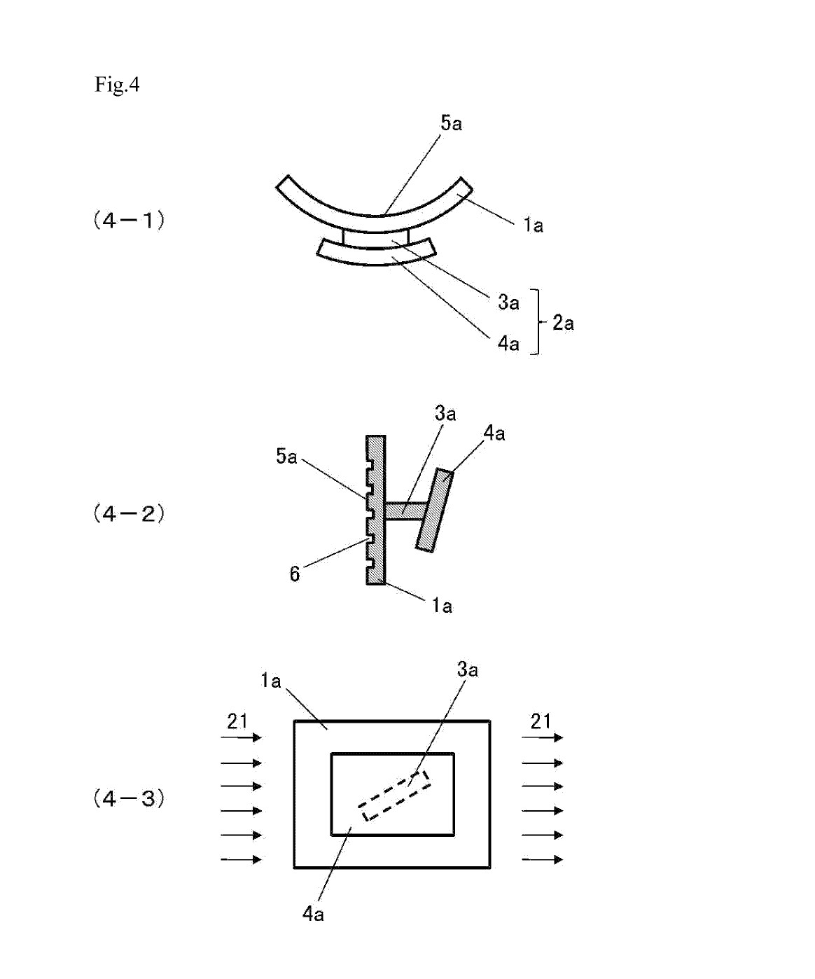

An example of a cylinder bore wall insulating member according to one embodiment of the invention and an internal combustion engine provided with the cylinder bore wall insulating member according to one embodiment of the invention are described below with reference to FIGS. 1 to 4. FIGS. 1 to 4 illustrate an example of the cylinder bore wall insulating member and a cylinder block in which the cylinder bore wall insulating member is disposed. FIG. 1 is a schematic plan view illustrating a state in which the cylinder bore wall insulating member is disposed in the cylinder block. FIG. 2 is an end view taken along the line x-x in FIG. 1. FIG. 3 is a perspective view illustrating the cylinder block illustrated in FIG. 1. FIG. 4 is a schematic view illustrating the cylinder bore wall insulating member illustrated in FIG. 1 (wherein (4-1) is a plan view, (4-2) is an end view (see FIG. 1), and (4-3) is a side view)). Note that a plurality of insulating members may actually be disposed in the cylinder block illustrated in FIG. 1, but only one insulating member is illustrated in FIG. 1 for convenience of illustration. In FIG. 2, the area lower than the two-dot chain line is omitted.

As illustrated in FIGS. 1 and 3, an open-deck cylinder block 11 for an automotive internal combustion engine (in which an insulating member 1a is disposed) includes bores 12 and a groove-like coolant passage 14, a piston moving upward and downward in each bore 12, and a coolant flowing through the groove-like coolant passage 14. The boundary between the bores 12 and the groove-like coolant passage 14 is defined by a cylinder bore wall 13. The cylinder block 11 also includes a coolant inlet 15 for supplying the coolant to the groove-like coolant passage 14, and a coolant outlet 16 for discharging the coolant from the groove-like coolant passage 14.

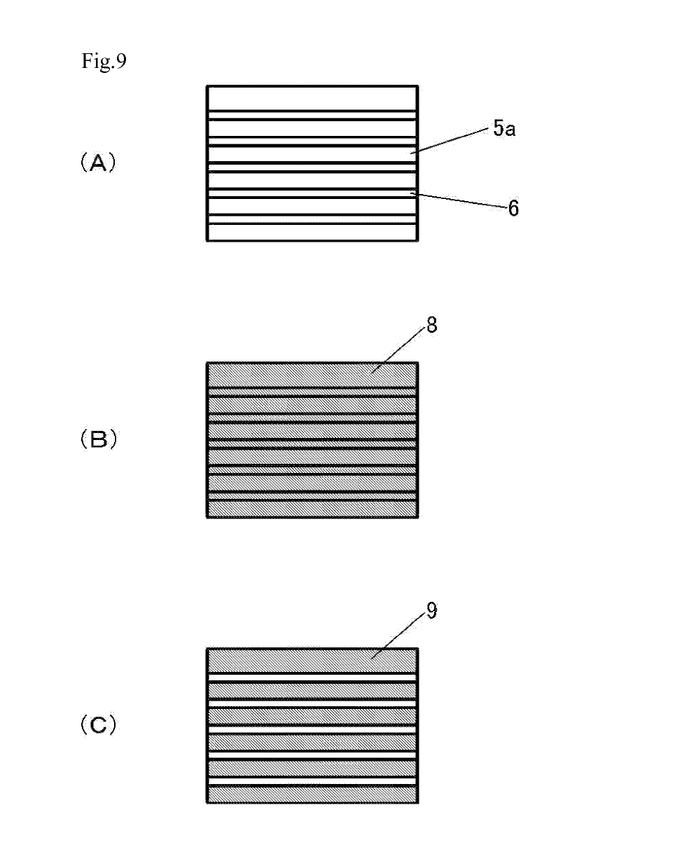

As illustrated in FIG. 4, the cylinder bore wall insulating member 1a has a contact surface 5a that comes in contact with the cylinder bore wall 13. The contact surface 5a is shaped to fit the wall surface of the cylinder bore wall 13 so that the contact surface 5a comes in contact with the wall surface of the cylinder bore wall 13. FIG. 9 is a view illustrating the contact surface 5a of the cylinder bore wall insulating member 1a illustrated in FIG. 4. As illustrated in FIG. 9 (see (A)), a plurality of transverse grooves 6 that extend in the transverse direction of the contact surface 5a are formed in the contact surface 5a in order to reduce the area of contact with the cylinder bore wall, the plurality of transverse grooves 6 being arranged in the vertical direction. A securing member 2a that includes a coupling section 3a and a wall contact section 4a is attached to the cylinder bore wall insulating member 1a. As illustrated in FIGS. 1 and 2, the cylinder bore wall insulating member 1a and the securing member 2a are disposed in the groove-like coolant passage 14 so that the contact surface 5a comes in contact with a wall surface 17 of the cylinder bore wall 13 that defines the groove-like coolant passage 14.

The internal combustion engine includes the cylinder block, the insulating member that is secured inside the groove-like coolant passage of the cylinder block using the securing member, a piston, a cylinder head, a head gasket, and the like.

As illustrated in FIG. 8, the cylinder bore wall insulating member 1a is put into the groove-like coolant passage 14 of the cylinder block 11 from above, and placed in the middle-lower area of the groove-like coolant passage 14.

The cylinder bore wall insulating member 1a is thus fitted into the groove-like coolant passage 14 of the cylinder block 11.

A cylinder bore wall insulating member according to a first embodiment of the invention (hereinafter may be referred to as “cylinder bore wall insulating member (1)”) has a contact surface that comes in contact with a wall surface of a cylinder bore wall that forms a cylinder block of an internal combustion engine and defines a groove-like coolant passage, the contact surface being formed of an elastomer or a resin material, and the ratio ((actual area of contact/formation area of contact surface)×100) of the actual area of contact to the formation area of the contact surface being 1 to 50%.

A cylinder bore wall insulating member according to a second embodiment of the invention (hereinafter may be referred to as “cylinder bore wall insulating member (2)”) has a contact surface that comes in contact with a wall surface of a cylinder bore wall that forms a cylinder block of an internal combustion engine and defines a groove-like coolant passage, the contact surface being formed of an elastomer or a resin material, and the coefficient of static friction of the contact surface having been reduced by subjecting the contact surface to processing that reduces the area of contact.

The cylinder bore wall insulating member (1) and the cylinder bore wall insulating member (2) have the contact surface that comes in contact with the wall surface of the cylinder bore wall that forms the cylinder block of the internal combustion engine and defines the groove-like coolant passage, and the contact surface is formed of an elastomer or a resin material.

The cylinder bore wall insulating member (1) and the cylinder bore wall insulating member (2) cover the wall surface of the cylinder bore wall that defines the groove-like coolant passage with the contact surface that comes in contract with the wall surface of the cylinder bore wall that defines the groove-like coolant passage. The cylinder bore wall insulating member (1) and the cylinder bore wall insulating member (2) thus prevent a situation in which the coolant comes in direct contact with the wall surface of the cylinder bore wall that defines the groove-like coolant passage.

The shape of the contact surface of the cylinder bore wall insulating member (1) and the cylinder bore wall insulating member (2) that comes in contact with the wall surface of the cylinder bore wall that defines the groove-like coolant passage is appropriately adjusted corresponding to each cylinder block so that the contact surface has a shape that coincides with the shape of the wall surface of the cylinder bore wall that defines the groove-like coolant passage.

The contact surface of the cylinder bore wall insulating member (1) and the cylinder bore wall insulating member (2) is formed of an elastomer or a resin material. Examples of the elastomer include a rubber material (e.g., solid rubber and rubber foam), a urethane foam (e.g., hard urethane foam and soft urethane foam), and the like. The contact surface may be formed of a solid rubber (e.g., natural rubber, butadiene rubber, ethylene-propylene-diene rubber (EPDM), nitrile-butadiene rubber (NBR), silicone rubber, and fluororubber); a rubber foam (e.g., ethylene-propylene-diene rubber (EPDM), nitrile-butadiene rubber (NBR), and fluororubber); a soft urethane; a hard urethane; or a resin material (e.g., thermoplastic resin (e.g., nylon resin) and thermosetting resin (e.g., phenol resin and melamine resin), taking account of long-life coolant resistance (LLC resistance) and heat resistance. It is preferable to use a rubber material (e.g., EPDM or NBR) as the material for forming the contact surface of the insulating member due to excellent elasticity, excellent adhesion, and excellent heat resistance.

When the cylinder bore wall insulating member (1) or the cylinder bore wall insulating member (2) is fitted into the groove-like coolant passage, the coolant does not come in contact with the insulation target part of the cylinder bore wall that defines the groove-like coolant passage. The shape, the arrangement, the placement position, the number, and the like of the cylinder bore wall insulating member (1) and the cylinder bore wall insulating member (2) are appropriately selected so that the cylinder bore wall (cylinder bore inner wall) has the desired temperature distribution.

The cylinder bore wall insulating member (1) and the cylinder bore wall insulating member (2) are used within the temperature range from −40 to 200° C. It is preferable that the cylinder bore wall insulating member (1) and the cylinder bore wall insulating member (2) can endure a temperature of 120° C. or more, and particularly preferably 150° C. or more. The cylinder bore wall insulating member (1) and the cylinder bore wall insulating member (2) are required to exhibit LLC resistance.

The cylinder bore wall insulating member (1) is characterized in that the ratio ((actual area of contact/formation area of contact surface)×100) of the actual area of contact to the formation area of the contact surface is 1 to 50%. When the ratio of the actual area of contact to the formation area of the contact surface is within the above range, it is possible to reduce the frictional force between the cylinder bore wall and the contact surface that occurs when fitting the cylinder bore wall insulating member into the groove-like coolant passage, and easily fit the cylinder bore wall insulating member into the groove-like coolant passage. If the ratio of the actual area of contact to the formation area of the contact surface exceeds 50%, the frictional force between the cylinder bore wall and the contact surface may increase to a large extent when fitting the cylinder bore wall insulating member into the groove-like coolant passage. On the other hand, it may be difficult to form the contact surface so that the ratio of the actual area of contact to the formation area of the contact surface is less than 1%.

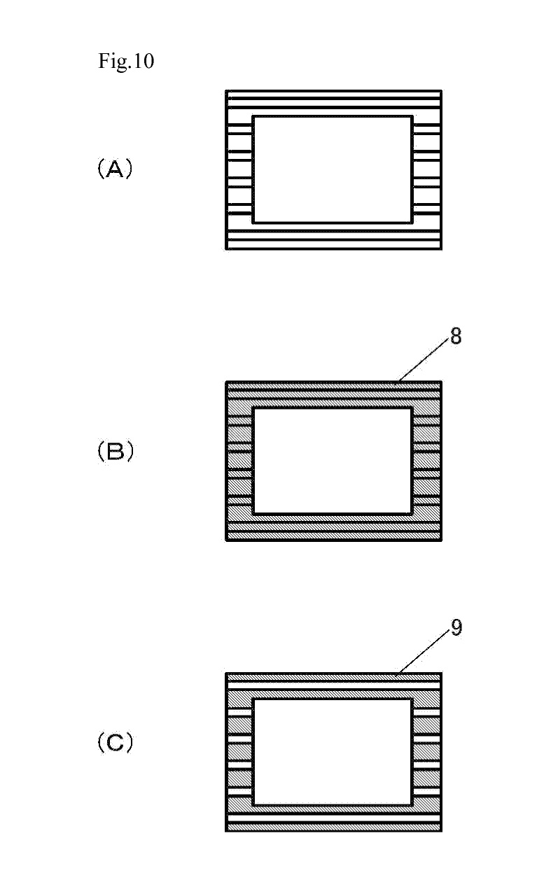

The details of the ratio ((actual area of contact/formation area of contact surface)×100) (%) of the actual area of contact to the formation area of the contact surface are described below with reference to FIG. 9. The formation area of the contact surface refers to the area of the range in which the contact surface is formed. When the cylinder bore wall insulating member is configured as illustrated in FIG. 4, the formation area of the contact surface refers to the area of the range indicated by the diagonal lines in (B) in FIG. 9. The actual area of contact refers to the area of part of the contact surface that comes in contact with the wall surface of the cylinder bore wall. Specifically, the actual area of contact is calculated by subtracting the area of part of the contact surface that does not come in contact with the wall surface of the cylinder bore wall (i.e., the total area of the transverse grooves 6 when the cylinder bore wall insulating member is configured as illustrated in FIG. 4) from the formation area of the contact surface. When the cylinder bore wall insulating member is configured as illustrated in FIG. 4, the actual area of contact refers to the total area of the ranges indicated by the diagonal lines in (C) in FIG. 9. When the contact surface is formed to have a hollow rectangular shape, and a plurality of transverse grooves 6 that extend in the transverse direction are formed in the contact surface (see (A) in FIG. 10), the formation area of the contact surface refers to the area or the range indicated by the diagonal lines in (B) in FIG. 10, and the actual area of contact refers to the total area of the ranges indicated by the diagonal lines in (C) in FIG. 10.

The cylinder bore wall insulating member (2) is characterized in that the coefficient of static friction of the contact surface has been reduced by subjecting the contact surface to processing that reduces the area of contact. When the coefficient of static friction of the contact surface has been reduced by subjecting the contact surface to processing that reduces the area of contact, it is possible to reduce the frictional force between the cylinder bore wall and the contact surface that occurs when fitting the cylinder bore wall insulating member into the groove-like coolant passage, and easily fit the cylinder bore wall insulating member into the groove-like coolant passage.

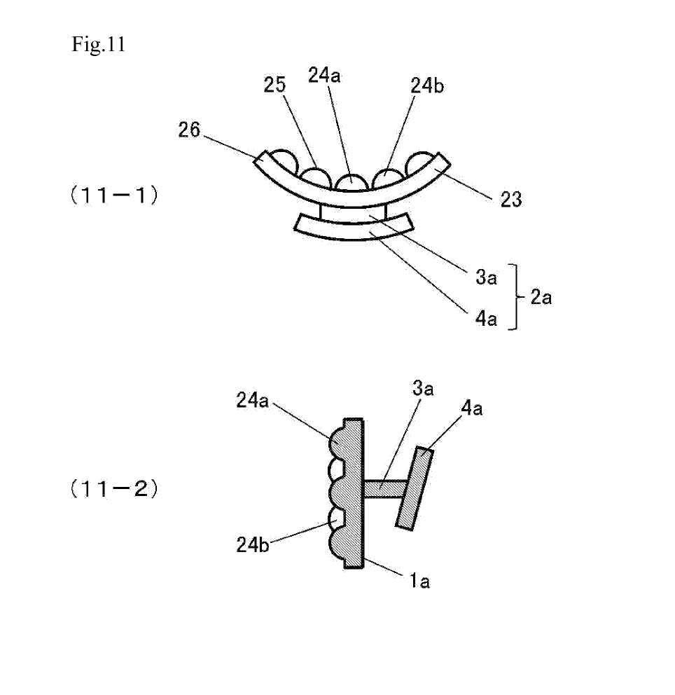

The processing that reduces the area of contact of the contact surface is not particularly limited as long as it is possible to reduce the actual area of contact of the contact surface to reduce the coefficient of static friction of the contact surface. The coefficient of static friction of the contact surface measured by a coefficient of static friction measurement test described below is preferably 0.01 to 0.5. The area of contact may be reduced by forming a plurality of transverse grooves in the contact surface (see FIGS. 4 and 10), or forming a plurality of vertical grooves in the contact surface, or forming a plurality of bulges on the contact surface (see FIG. 11), for example.

FIG. 11 is a schematic view illustrating another example of the cylinder bore wall insulating member, wherein (A) is a plan view, and (B) is a cross-sectional view. As illustrated in FIG. 11, a cylinder bore wall insulating member 23 includes a base 26 that is shaped to fit the wall surface of the cylinder bore wall, and a plurality of approximately hemispherical bulges 24 that are formed on the base 26 (on the side on which the cylinder bore wall insulating member 23 comes in contact with the cylinder bore wall). Specifically, the cylinder bore wall insulating member 23 includes a plurality of approximately hemispherical bulges 24 that are formed on the side on which the cylinder bore wall insulating member 23 comes in contact with the cylinder bore wall, and the approximately hemispherical bulges 24 and the base 26 are formed of an elastomer or a resin material. A securing member 2a that includes a coupling section 3a and a wall contact section 4a is attached to the base 26. The approximately hemispherical bulges 24 are deformed when the cylinder bore wall insulating member 23 is fitted into the groove-like coolant passage so that the approximately hemispherical bulges 24 are crushed by the cylinder bore wall, and part of the surface of each approximately hemispherical bulge 24 comes in contact with the wall surface of the cylinder bore wall. Specifically, part of the surface of each approximately hemispherical bulge 24 that is deformed when the cylinder bore wall insulating member 23 is fitted into the groove-like coolant passage and comes in contact with the wall surface of the cylinder bore wall serves as a contact surface 25. Since only part of the surface of each approximately hemispherical bulge 24 comes in contact with the wall surface of the cylinder bore wall when the cylinder bore wall insulating member 23 is fitted into the groove-like coolant passage, the area of contact of the contact surface of the cylinder bore wall insulating member 23 is reduced.

The coefficient of static friction of the contact surface is measured as described below. An aluminum alloy tabular sheet that has been polished to have the same surface roughness as that of the wall surface of the groove-like coolant passage of the cylinder block, a specimen (40×40×15 mm), and a weight to which the specimen is bonded to apply a load to the specimen, are provided. The side of the specimen opposite to the measurement target side (coefficient of static friction measurement target side) (i.e., the side that comes in contact with the aluminum alloy tabular sheet) is bonded to the center of the weight. The weight to which the specimen is bonded is placed on the aluminum alloy tabular sheet so that the measurement target side of the specimen comes in contact with the aluminum alloy tabular sheet (i.e., the specimen is sandwiched between the aluminum alloy tabular sheet and the weight). The weight is then pulled in the horizontal direction to measure the maximum tensile load. The coefficient of static friction is calculated using the following expression.

Coefficient of static friction=maximum tensile load (N)/weight (N) of weight

Note that the coefficient of static friction of the contact surface varies depending on the type, the hardness, the surface shape, and the like of the material that forms the contact surface. Therefore, the type, the hardness, the surface shape, and the like of the material that forms the contact surface are appropriately selected so that the coefficient of static friction of the contact surface falls within the above range.

The cylinder bore wall insulating member may include a reinforcing material (that is provided inside the insulating member, or provided on the back surface opposite to the contact surface) so that the shape of the insulating member can be maintained.

The cylinder bore wall insulating member is secured using the securing member so that the contact surface comes in contact with the cylinder bore wall. In the example illustrated in FIGS. 1, 2, and 4, the cylinder bore wall insulating member 1a is secured using the securing member 2a. The securing member 2a includes the coupling section 3a and the wall contact section 4a. The wall contact section 4a comes in contact with a wall surface 18 of the groove-like coolant passage 14 opposite to the cylinder bore wall 13. Therefore, the contact surface of the wall contact section 4a is shaped to be fitted to the wall surface 18. The coupling section 3a couples the insulating member 1a and the wall contact section 4a. It is preferable that the coupling section 3a be tilted upward relative to a flow direction 21 of the coolant (see (4-3) in FIG. 4) so that a force that presses the insulating member 1a and the wall contact section 4a against the bottom of the groove-like coolant passage 14 is applied to the insulating member 1a and the wall contact section 4a due to the flow of the coolant, and the insulating member 1a is pressed against and secured on the cylinder bore wall 13. Note that the coupling section 3a is outlined by the dotted line in (4-3) in FIG. 4.

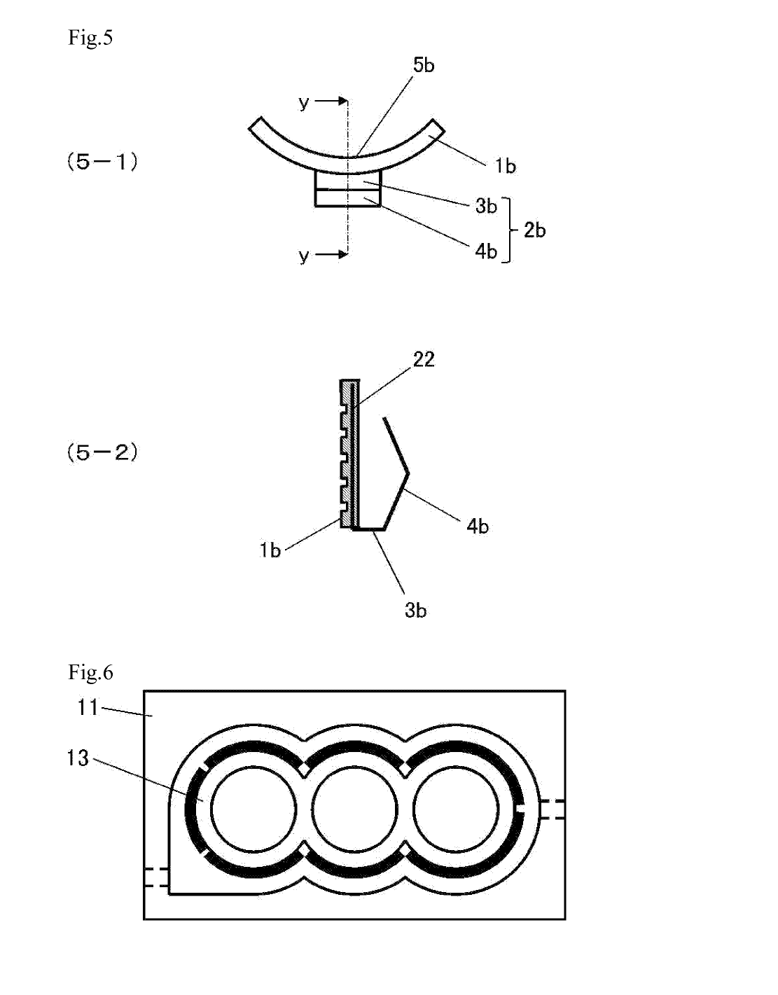

The securing member used to secure the cylinder bore wall insulating member is not limited to that illustrated in FIGS. 1, 2, and 4. As illustrated in FIG. 5, the securing member may include a coupling section 3b, a wall contact section 4b, and an embedded section 22, for example. FIG. 5 is a schematic view illustrating another example of the cylinder bore wall insulating member and the securing member, wherein (5-1) is a plan view illustrating the securing member, and (5-2) is an end view taken along the line y-y in (5-1). The embedded section 22 is embedded in an insulating member 1b. The insulating member 1b is pressed against and secured on the cylinder bore wall due to a spring biasing force applied by the coupling section 3b, the wall contact section 4b, and the embedded section 22.

Note that the securing member is not limited to the above examples as long as the insulating member can be secured inside the groove-like coolant passage of the cylinder block so that the contact surface of the insulating member comes in contact with the wall surface of the cylinder bore wall.

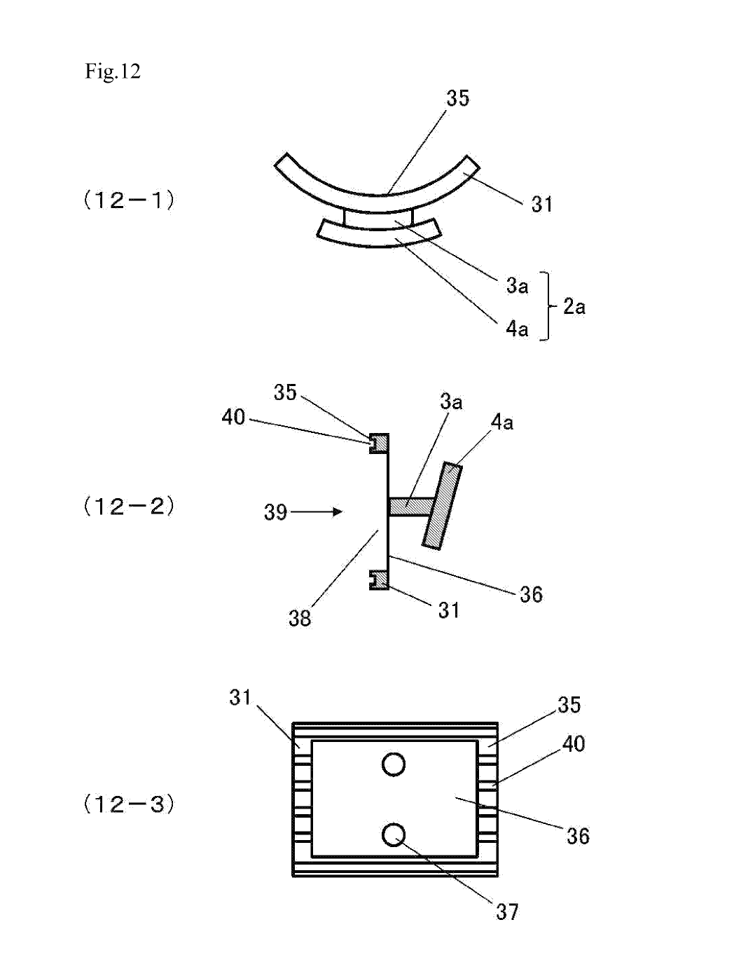

In the example illustrated in FIGS. 1, 2 and 4, the contact surface is formed to have a rectangular shape. Note that the shape of the contact surface of the cylinder bore wall insulating member is not limited thereto. For example, the contact surface of the cylinder bore wall insulating member may have the configuration illustrated in FIG. 12. FIG. 12 is a schematic view illustrating another example of the cylinder bore wall insulating member, wherein (12-1) is a plan view, (12-2) is an end view, and (12-3) is a front view (illustrating the contact surface). As illustrated in FIG. 12, a cylinder bore wall insulating member 31 has a contact surface 35 that comes in contact with the cylinder bore wall. The contact surface 35 is shaped to fit the wall surface of the cylinder bore wall so that the contact surface 35 comes in contact with the wall surface of the cylinder bore wall. A plurality of transverse grooves 40 that extend in the transverse direction are formed in the contact surface 35, the plurality of transverse grooves 40 being arranged in the vertical direction. The contact surface 35 is formed to have a hollow rectangular shape (see (12-3) in FIG. 12) when viewed in the direction indicated by reference sign 39 (see (12-2) in FIG. 12) so that the contact surface 35 encloses the vicinity of the outer edge of the insulation target part of the wall surface of the cylinder bore wall. The cylinder bore wall insulating member 31 is secured on an insulating member holding plate 36. A securing member 2a that includes a coupling section 3a and a wall contact section 4a is attached to the holding plate 36.

Since the contact surface 35 of the cylinder bore wall insulating member 31 is formed to have a hollow rectangular shape when viewed in the direction indicated by reference sign 39 so that the contact surface 35 encloses the vicinity of the outer edge of the insulation target part of the wall surface of the groove-like coolant passage, the contact surface 35 comes in contact with only the vicinity of the outer edge of the insulation target part of the wall surface of the groove-like coolant passage, and does not come in contact with the area of the wall surface of the groove-like coolant passage situated inside the outer edge of the insulation target part. A through-hole 37 is formed in the insulating member holding plate 36. When the cylinder bore wall insulating member 31 is fitted into the groove-like coolant passage, and the coolant is passed through the groove-like coolant passage, the coolant flows into an inner part 38 of the insulating member 31 through the through-hole 37. The coolant that has entered the inner part 38 of the insulating member 31 is confined with the space formed by the wall surface of the groove-like coolant passage, the cylinder bore wall insulating member 31, and the insulating member holding plate 36, and increases in temperature since the coolant that flows through the space outside the insulating member holding plate 36 rarely enters the inner part 38 of the insulating member 31. Therefore, the insulation target part of the wall surface of the groove-like coolant passage is covered with (insulated by) the coolant that has entered the inner part 38 of the insulating member 31 and increased in temperature, and the cylinder bore wall insulating member 31 that comes in contact with the vicinity of the outer edge of the insulation target part of the wall surface of the groove-like coolant passage.

The overall shape of the cylinder bore wall insulating member and the shape of the securing member are not particularly limited as long as the flow of the coolant in the groove-like coolant passage is not hindered.

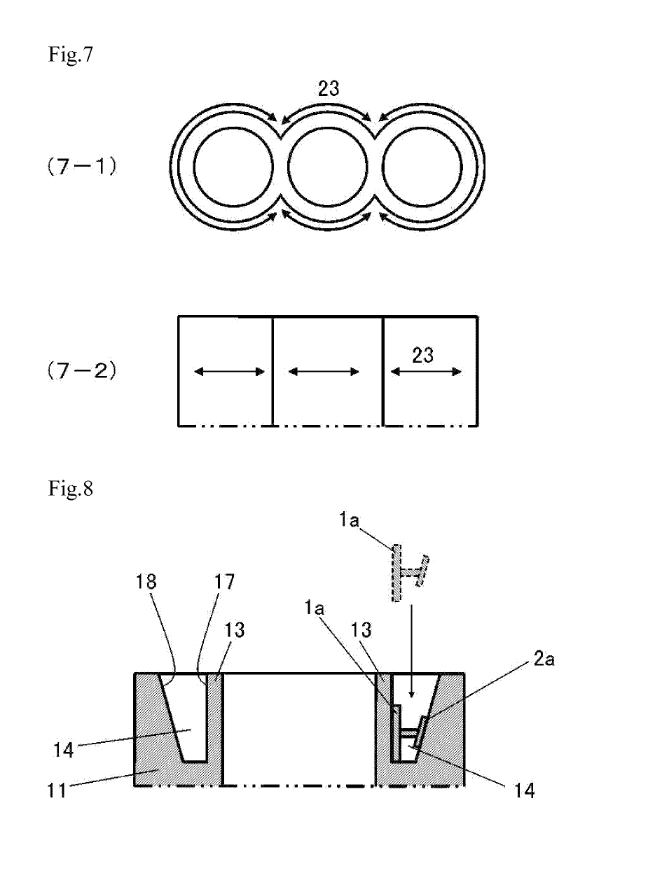

In the example illustrated in FIG. 1, only one side of the wall surface of the center cylinder bore among the three cylinder bores is insulated by the cylinder bore wall insulating member. Note that the configuration is not limited thereto. As illustrated in FIG. 6, the entirety of the cylinder bore wall in the circumferential direction may be covered with the cylinder bore wall insulating member. Alternatively, part of the cylinder bore wall in the circumferential direction may not be covered with the cylinder bore wall insulating member. In FIG. 6, the black area represents the placement position of the insulating member. The term “circumferential direction” used herein in connection with the cylinder bore wall (see 23 in FIG. 7) refers to a direction that extends along the cylinder bore wall 13 (i.e., the transverse direction when the cylinder bore wall 13 is viewed from the side). Note that (7-1) in FIG. 7 is a plan view illustrating only the cylinder bore wall 13, and (7-2) in FIG. 7 is a front view illustrating only the cylinder bore wall 13.

In the example illustrated in FIG. 1, the cylinder bore wall insulating member comes in contact with only one side of the wall surface of the center cylinder bore among the three cylinder bores. Note that the configuration is not limited thereto. For example, the cylinder bore wall insulating member may be shaped to come in contact with the bore walls of two or more cylinder bores. In this case, two or more cylinder bore wall insulating members 1a illustrated in FIG. 1 may be connected side by side, for example.

The cylinder bore wall insulating member is disposed in the internal combustion engine so that the upper end of the cylinder bore wall insulating member in the vertical direction is situated at a position lower than the position that is lower than the upper end of the groove-like coolant passage by ⅓rd of the length from the upper end to the lower end of the groove-like coolant passage. In FIG. 2, the position that is lower than the upper end of the groove-like coolant passage by ⅓rd of the length from the upper end to the lower end of the groove-like coolant passage refers to the position that is lower than an upper end 131 of the groove-like coolant passage by ⅓rd of the length from the upper end 131 to a lower end 132 of the groove-like coolant passage. It is preferable that the position of the lower end of the cylinder bore wall insulating member in the vertical direction coincide with the position of the lower end 132 of the groove-like coolant passage. Note that the lower end of the cylinder bore wall insulating member in the vertical direction may be situated at a position higher than the lower end 132 of the groove-like coolant passage taking account of the production of the cylinder bore wall insulating member, the shape of the groove-like coolant passage, and the like as long as the advantageous effects of the invention are not impaired.

### REFERENCE SIGNS LIST

1, 1a, 1b, 31: Insulating member
2a, 2b: Securing member
3a, 3b: Coupling section
4a, 4b: Wall contact section
5b, 5b, 25, 35: Contact surface
6, 40: Transverse groove
8: Formation area of contact surface
9: Actual area of contact
11: Cylinder block
12: Bore
13: Cylinder bore wall
14: Groove-like coolant passage
15: Coolant inlet
16: Coolant outlet
17: Wall surface of cylinder bore wall 13 that defines groove-like coolant passage 14
18: Wall surface of groove-like coolant passage 14 opposite to cylinder bore wall 13
21: Coolant flow direction
22: Embedded section
23: Circumferential direction of cylinder bore wall
24: Hemispherical bulge
26: Base
36: Insulating member holding plate
37: Through-hole
131: Upper end of groove-like coolant passage
132: Lower end of groove-like coolant passage

1. A cylinder bore wall insulating member having a contact surface that comes in contact with a wall surface of a cylinder bore wall that forms a cylinder block of an internal combustion engine and defines a groove-like coolant passage, the contact surface being formed of an elastomer or a resin material, and a ratio ((actual area of contact/formation area of contact surface)×100) of an actual area of contact to a formation area of the contact surface being 1 to 50%.

2. A cylinder bore wall insulating member having a contact surface that comes in contact with a wall surface of a cylinder bore wall that forms a cylinder block of an internal combustion engine and defines a groove-like coolant passage, the contact surface being formed of an elastomer or a resin material, and a coefficient of static friction of the contact surface having been reduced by subjecting the contact surface to processing that reduces an area of contact.

3. The cylinder bore wall insulating member according to claim 1, wherein the contact surface is formed of an ethylene-propylene-diene rubber, a nitrile-butadiene rubber, a silicone rubber, or a fluororubber.

4. The cylinder bore wall insulating member according to claim 2, wherein the contact surface is formed of an ethylene-propylene-diene rubber, a nitrile-butadiene rubber, a silicone rubber, or a fluororubber.
